(19) United States
(12) Patent Application Publication
(10) Pub. No.: US 2026/0342176 A1
(43) Pub. Date: Oct. 29, 2026

(54) ELECTRICAL MACHINE WITH OVERMOLDED STATOR AND METHOD FOR PRODUCING AN ELECTRICAL MACHINE

(71) Applicant: MAGNA POWERTRAIN GMBH & CO KG, Lannach (AT)

(72) Inventors: Birgit Lipp, Markt Hartmannsdorf (AT); Werner Ness, Manhartsbrunn (AT); Stefan Lienhart, Graz (AT); Matthias Kohlhauser, Fernitz (AT)

(21) Appl. No.: 19/099,830

(22) PCT Filed: Jul. 21, 2023
(86) PCT No.: PCT/EP2023/070269

§ 371 Date: Jan. 30, 2025

(30) Foreign Application Priority Data
Aug. 3, 2022 (DE) 10 2022 208 046.7

(51) Int. Cl. H02K 9/197; H02K 3/24; H02K 15/12

(52) U.S. Cl. CPC H02K 9/197; H02K 3/24; H02K 15/12

(57) ABSTRACT

An electrical machine with oil cooling includes a rotor and a stator sealed against the rotor, located in a space wetted with oil and arranged within a housing of the electrical machine. The stator is formed of stator laminations having radially running winding grooves. The stator laminations have a seal injection molded along their inner radii and the winding grooves are coated with an insulation from the same injection molding material.

### CROSS-REFERENCE TO RELATED APPLICATIONS

This application is a National Stage of International Application No. PCT/EP2023/070269, filed on Jul. 21, 2023, which claims priority to DE 10 2022 208 046.7, filed on Aug. 3, 2022. The entire disclosures of each of the above applications are incorporated herein by reference.

### FIELD

The present disclosure relates to an oil-cooled electric machine with a rotor and with a stator sealed with respect to the rotor, which is arranged in the oil-wetted space of the electric machine.

The present disclosure also relates to a method for producing an electric machine.

### BACKGROUND

This section provides information related to the present disclosure which is not necessarily prior art.

Electric drives for vehicles are gaining in importance. Key components are the electric machines and the arrangement for efficient cooling thereof. In addition to arrangements for cooling the rotor, the stator of the electric machine is also cooled, this being required for medium to relatively high power outputs.

Various approaches for cooling the stator are known, such as cooling via a cooling jacket, or cooling the winding heads from outside via a distribution mechanism.

A cooling of the stator via special central stator grooves is also known, wherein coolants are routed axially toward the winding of the stator through axial ducts in the stator yoke and are distributed to the winding heads via a part made of synthetic material.

There are also winding heads overmolded with synthetic material, with integrated cooling ducts.

An electric machine with a rotor and a stator is known from US 2015/076954 A1. The stator comprises an annular core, several stator wedges and several wedge-retaining structures.

The core includes a large number of teeth, spaced in arcuate manner. An overmolding covers substantially the entire core. The overmolding comprises a synthetic-resin material and most preferably comprises polyethylene. The overmolding defines the wire-routing structure and the stator-mounting structure. The walls are not concentric, or the routing is achieved via hooks and portals instead of via the walls.

The overmolding of active parts of the electric machine is currently a tried and tested approach in order to meet various requirements in the electric traction drive. Exemplary known realizations are the overmolded rotor, in which case the overmolding serves for positioning and fixing the magnets as well as the electric sheets relative to one another.

An overmolded stator for fixing the windings in the slots and in the integrated axial cooling ducts is also known.

Furthermore, winding heads are overmolded together with wiring for thermal linkage and positioning of the bus bars.

The cooling that has been achieved hitherto is inadequate, because only a superficial cooling of the stator takes place. The stator yoke is cooled only from outside via the housing of the electric machine and a cooling jacket; the winding heads are cooled only by means of coolants applied by spraying. The principal input of heat, however, arises in the winding grooves.

In this process, an increased drag loss, or poor efficiency, arises as a result of excess oil on the rotor or in the air gap of the electric machine.

In the case of an overmolding of the windings over their entire surface, inferior thermal transfers into the cooling medium are obtained by reason of the inferior thermal conductivity of synthetic material.

A separate insulating paper is required between stator and winding.

DE 10 2018 219 816 A1 and DE 10 2018 219 818 A1 present a solution for embedding the stator windings of an electric machine together with a cooling duct which is capable of being flowed through by coolant, for cooling the stator windings, in a synthetic material which typically combines electrically insulating and thermally conducting properties. Through the use of a synthetic material with electrically insulating properties, it is additionally ensured that the stator windings, to be cooled, through the electrical synthetic material are not electrically short-circuited in undesirable manner with the synthetic material routed through the cooling duct. In addition, it is ensured that the—typically electrically conducting—coolant is electrically insulated with respect to the stator windings when it flows through the cooling duct. Over and above that, the stator teeth as part of the stator can also be electrically insulated with respect to the stator windings by means of the synthetic material.

DE 10 2017 101 094 A1 encompasses a sealing device which can be inserted into the grooves at the same time. Consequently several sealing devices, one of which is inserted into a respective one of the grooves, are not needed. The term “inserted” in this context is also to be understood to mean that the sealing means is poured in, injected or pressed in. Windings of an electrical coil, which are needed for the operation of the electric drive machine, may be arranged in the grooves. The sealing device takes the form of an electrical insulator. The sealing device is designed to seal off the grooves with respect to the rotor. The sealing device is formed in one piece or in one part. The one-piece or one-part configuration of the sealing device has the advantage that the sealing device can be inserted into the grooves in one working step, in order to seal off the grooves.

### SUMMARY

This section provides a general summary of the disclosure and is not a comprehensive disclosure of its full scope or all of its features.

The object of the present disclosure is to present a purely oil-cooled EM with a stator immersed directly in the oil, in order to obtain superior cooling effects and consequently an increased continuous output over speed.

The object is achieved with an oil-cooled electric machine having a rotor and a stator sealed with respect to the rotor, which is arranged in the oil-wetted space within a housing of the electric machine, wherein the stator is constructed from stator sheets which exhibit radially extending winding grooves, wherein the stator sheets exhibit a seal including synthetic material along their inside radii, and the winding grooves are lined with an insulation with the same synthetic material.

By application of the injection-molding process, thin wall thicknesses can be achieved in the course of the realization of a directly overmolded stator. As a result, it is possible to make the air gap between rotor and stator as small as possible, in order to avoid losses of power.

The insulation of the winding grooves includes retaining lugs by way of abutment for winding wire, which have been produced with the same synthetic material in an injection-molding process. As a result, simple production of these abutments for the winding wire is obtained.

According to some aspects of the present disclosure, it is also permissible that the insulation is provided—additionally or exclusively—by one or more discrete insulating structures (for example, non-conducting tabs or overlays) and/or by at least partial coating of the core with an electrically conducting layer.

Inserts for retaining lugs by way of abutment for a winding wire may also have been overmolded.

The retaining lugs serve not only as stops but also as radial boundary of cooling ducts in the winding grooves.

The electric machine—more precisely, the stator—is further sealed, the seal extending axially into a gasket attached by injection molding or into an overmolded gasket insert with abutment against a housing of the electric machine.

An auxiliary gasket has also been attached by injection molding on the front side of the stator sheet.

The stator sheets exhibit fixing grooves on their outside radius, which have been formed by injection molding with synthetic material. As a result, the sheets are fixed and connected, so that a saving can be made by dispensing with laser welding.

The object is also achieved with a method for producing an electric machine, with the following steps:
producing and laminating stator sheets,
inserting the sheet pack into an injection mold,
forming fixing grooves by injection molding on the outside radius of the sheet pack,
simultaneously producing insulation in the winding grooves,
simultaneously producing the seal.

Simultaneous production of a gasket attached by injection molding, with or without gasket insert, starting from the seal to the housing of the electric machine may also be effected.

The injection-molding procedure consequently permits sheet packs to be fixed, permits the seals to be produced, and permits the insulation of the winding grooves to be implemented simultaneously.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows a section through a stator with winding grooves,

FIG. 2 shows another section through a stator with winding grooves,

FIG. 3 shows another section through a stator with winding grooves,

FIG. 4 shows an enlargement of the winding grooves,

FIG. 5 shows another enlargement of the winding grooves,

FIG. 6 shows an embodiment of an electric machine in a longitudinal section,

FIG. 7 shows another embodiment of an electric machine in a longitudinal section,

FIG. 8 shows another embodiment of an electric machine in a longitudinal section,

FIG. 9 shows a fastening of stator sheets by overmolding,

FIG. 10 shows another view of a fastening of stator sheets by overmolding,

FIG. 11 shows another view of a fastening of stator sheets by overmolding.

### DETAILED DESCRIPTION

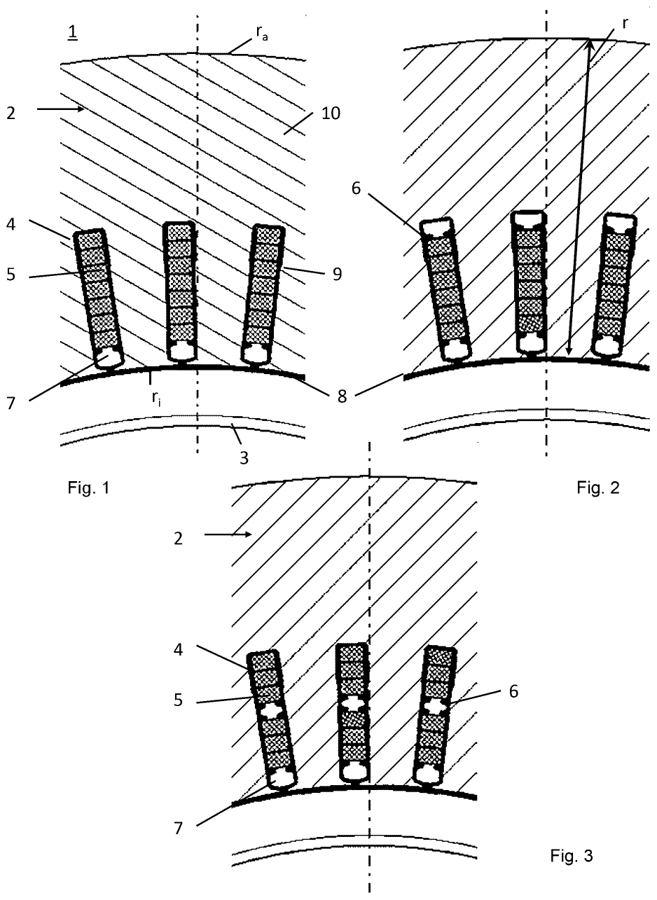

Sections through a stator 2 of an electric machine 1 with a rotor 3 are shown in FIGS. 1 to 3. The stator 2 exhibits stator sheets 10 in which winding grooves 4 have been formed. In this exemplary embodiment, the winding grooves extend only to a fraction of the radius r of the stator sheets 10.

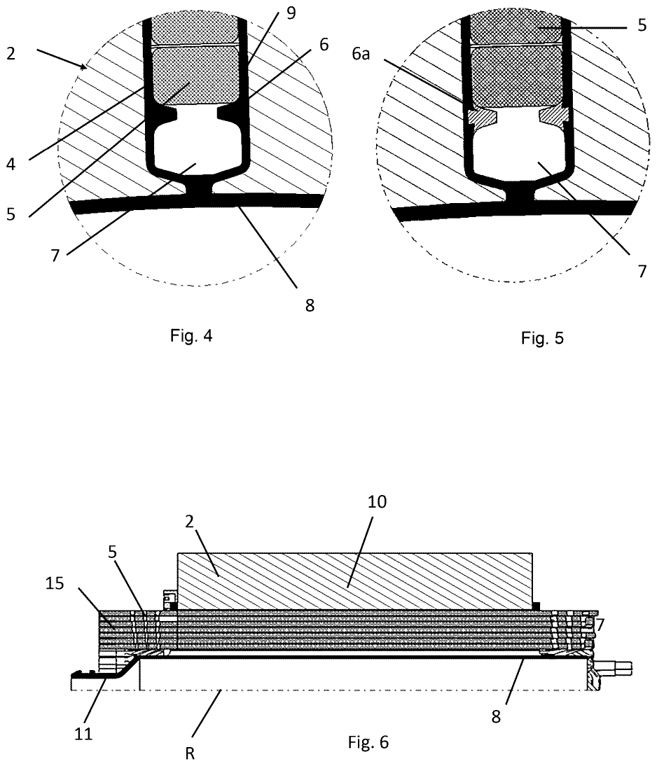

A seal 8 relative to the rotor 3 is represented along the inside radius rᵢ of the stator 2. The seal 8 is a layer of synthetic material which is injected over the stator sheets. At the same time, winding grooves 4 are provided with an insulation 9 which lines the winding grooves 4 with a synthetic material. The two layers of synthetic material merge with one another in the region of the seal 8 with respect to the rotor 3 (see FIGS. 4 and 5).

This seal 8 of the stator space relative to the rotating rotor 3 is required in order to seal the stator 2.

Retaining lugs or positioning lugs 6 have been inserted in the radial contour of the winding grooves 4. The retaining lugs 6 are produced in the injection-molding process simultaneously with the insulation 9.

FIG. 4 shows an enlargement of an embodiment of a winding groove 4 with retaining lugs 6. The retaining lugs 6 serve for routing winding wire 5 which is inserted in the form of hairpin structures into the winding groove 4. At the same time, however, the retaining lugs 6 also define cooling ducts 7 in the winding groove 4. In FIG. 1, a series of cooling ducts 7 has been configured close to the seal 8. In FIG. 2, two sets of cooling ducts are produced, by retaining lugs 6 keeping the two end regions of the winding grooves 4 clear. In FIG. 3, a set of cooling ducts 7 has been produced in the middle of the winding grooves 4, by retaining lugs 6 being provided at a total of four positions on the winding groove 4.

In FIG. 5, an alternative embodiment is shown, in which the retaining lugs 6 have been replaced by inserts 6a. The inserts 6a are inserted into the winding grooves 4 in the process of injection of the insulation 9.

The stator 2 is overmolded directly and, in combination with the winding grooves 4, which are also overmolded, constitutes the load-bearing structure of the seal. Consequently the sealing surface, or wall thickness, relative to the dry rotor space can be made as thin-walled as possible, in order to keep the enlargement of the air gap as small as possible. In addition, the insulating paper is dispensed with by virtue of the overmolding of the winding grooves 4.

The cooling ducts 7 are formed by purposeful positioning of the windings, or hairpin wires, in the winding grooves 4.

The overmolding of the stator also permits the arrangement of gaskets such as are represented in FIGS. 6, 7 and 8.

FIG. 6 shows a gasket 11 attached by injection molding which extends from the seal 8 with respect to the rotor 3 toward a housing 14, not represented in this drawing, but shown for example in FIG. 8. The gasket 11 attached by injection molding extends axially in the extension of the seal 8. The gasket 11 attached by injection molding is curved radially inward and then extends with a smaller radius relative to the axis of rotation R than the seal 8. This gasket 11 attached by injection molding extends within the radius of the winding heads 15.

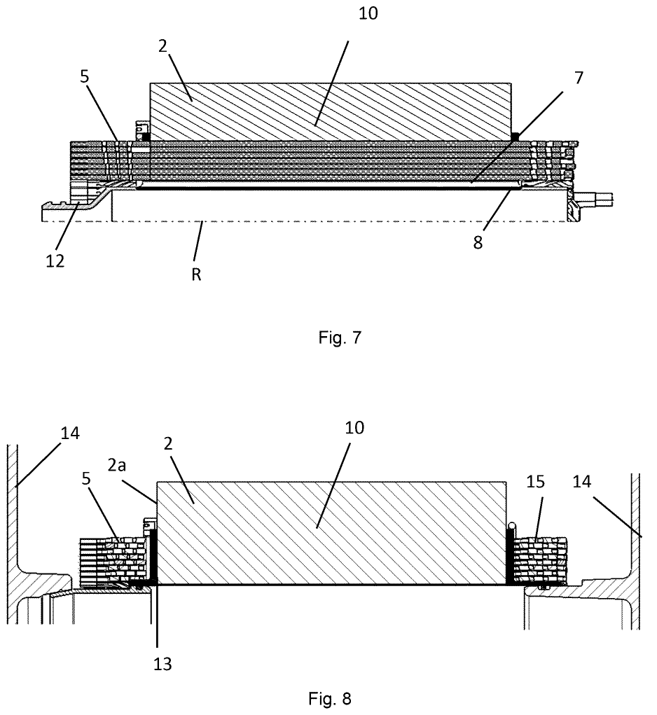

An alternative embodiment is represented in FIG. 7. If the material of the seal 8 is not optimally suited for sealing the stator 2 with respect to the housing 14 of the electric machine 1, use is made of a gasket insert 12. This gasket insert 12 extends like the gasket 11 attached by injection molding, but is inserted into the mold as a separate inserted part prior to the injection-molding method.

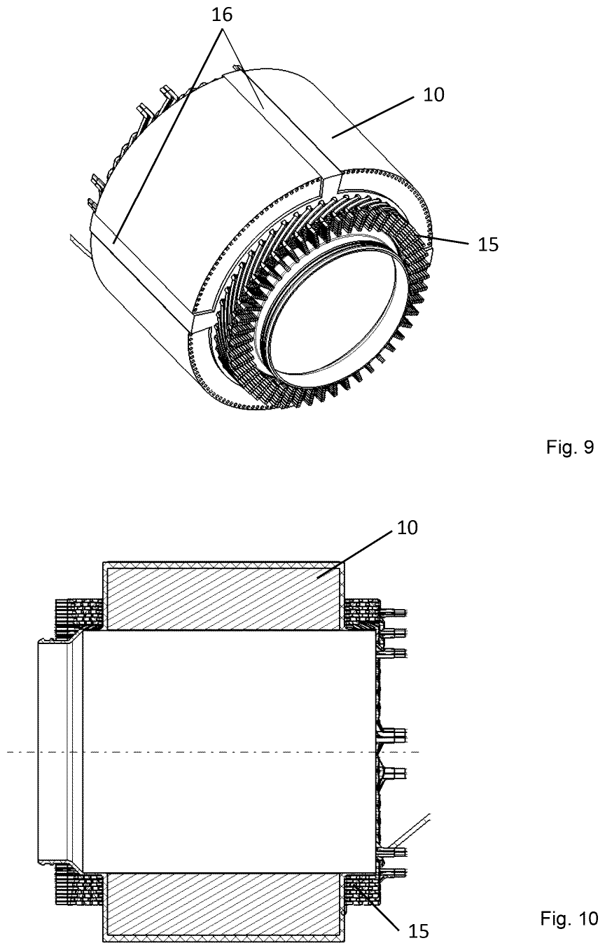

In FIG. 9 it is represented that an auxiliary gasket 13 can be inserted by injection molding. This auxiliary gasket 13 extends radially on the front side 2a of the stator 2. This layer of synthetic material of the auxiliary seal 13 seals the sheet pack beneath the winding heads 15.

With the various gaskets (11, 12, 13) attached by injection molding or inserted, the stator sheet 10 is completely sealed with respect to the rotor 3 of the electric machine 1.

Because the stator 2 is already being partially overmolded with synthetic material, a further aspect in the implementation is conceivable.

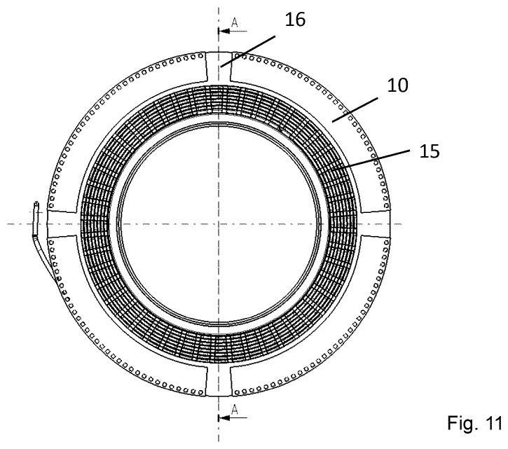

FIGS. 9, 10 and 11 show images of the entire stator sheet 10 in various views. On its outside radius rₐ the stator sheet 10 exhibits fixing grooves 16 which extend axially along the sheet pack. These grooves 16 extend radially to a depth at which the winding grooves 4 begin. In the exemplary embodiment, four fixing grooves 16 are distributed axially.

The sheets of the stator 2 are produced in a stamping process and are subsequently stacked on top of one another. This sheet pack consisting of stator sheets 10 is inserted directly into the cavity of an injection-molding tool immediately after the packaging process for the electric sheets and is overmolded.

All the moldings, or prepared inserts, that are needed in order to seal and finalize the stator 2 are to be found in the injection-molding tool.

### LIST OF REFERENCE SIGNS

1 electric machine

2 stator

3 rotor

4 winding groove

5 winding wire

6 retaining or positioning lugs

6a insert, retaining lug

7 cooling ducts

8 seal relative to the rotor

9 insulation

10 stator sheets

11 gasket attached by injection molding

12 gasket insert

13 auxiliary gasket

14 housing

15 winding head

16 fixing groove

R axis of rotation

rₐ outside radius

rᵢ inside radius

What is claimed is:

1. An oil-cooled electric machine comprising:
a rotor and a stator sealed with respect to the rotor, which is arranged in an oil-wetted space within a housing of the electric machine,
wherein the stator includes stator sheets having radially extending winding grooves,
wherein the stator sheets include, along an inside radii of the stator sheets, a seal with respect to the rotor,
wherein the seal is made of a synthetic material, and
wherein the winding grooves are lined with an insulation wherein the insulation is made of the same synthetic material,
wherein the insulation of the winding grooves includes retaining elements in the form of retaining lugs or inserts attached to the insulation, wherein the retaining lugs or inserts are provided for abutment with the winding wire,
wherein the retaining lugs or inserts define a radial boundary of cooling ducts in the winding grooves.

2. The electric machine as claimed in claim 1, wherein the retaining elements are the retaining inserts, wherein the insulation of the winding grooves includes the inserts for abutment with the winding wire, wherein the inserts are attached to the insulation in an injection-molding process.

3. The electric machine as claimed in claim 1, wherein the seal extends axially into a gasket or into an overmolded gasket insert, wherein the gasket or overmolded gasket insert is in abutment against the housing of the electric machine.

4. The electric machine as claimed in claim 1, wherein an auxiliary gasket is attached to the seal by injection molding on a front side of the stator sheet.

5. The electric machine as claimed in claim 1, wherein the stator sheets include fixing grooves on their outside radius, which have been formed by injection molding with synthetic material.

6. A method for producing an electric machine as claimed in claim 1, the method comprising:
producing and laminating the stator sheets,
inserting a sheet pack including the stator sheets into an injection mold,
in an injection molding process:
forming fixing grooves by injection molding on the outside radius of the stator sheets,
producing the insulation in the winding grooves, and
producing the seal.

7. The method as claimed in claim 6, further comprising:
producing a gasket attached to the seal in the injection molding process, wherein the gasket extends from the seal to the housing of the electric machine.

8. The method as claimed in claim 6, further comprising attaching a gasket insert to the seal in the injection molding process, wherein the gasket insert extends from the seal to the housing of the electric machine.

9. The method as claimed in claim 6, further comprising producing an auxiliary gasket in the injection molding process, wherein the auxiliary gasket is attached to the seal in the injection molding process and extends across a front face of the stator.

10. The method as claimed in claim 6, further comprising integrally forming the retaining lugs with the insulation in the injection molding process, wherein the retaining lugs are made of the same material as the insulation.

11. The method as claimed in claim 6, further comprising attaching the retaining inserts to the insulation during the injection molding process.

12. The method as claimed in claim 6, further comprising inserting winding wire into the winding grooves and into abutment with the retaining lugs or inserts.

13. The method as claimed in claim 12, further comprising defining the cooling ducts adjacent the retaining lugs or inserts and adjacent the inserted winding wire.

14. The electric machine as claimed in claim 1, wherein the retaining inserts are the retaining lugs, wherein the retaining lugs are produced with the same synthetic material and integrally formed with the insulation in an injection molding process.

15. The electric machine as claimed in claim 1, wherein the gasket is integrally formed as an extension of the seal via injection molding.

16. The electric machine as claimed in claim 1, wherein the insulation intersects the seal at the inner radii of the stator sheets.
